(19) United States
(12) Patent Application Publication
(10) Pub. No.: US 2008/0309702 A1
(43) Pub. Date: Dec. 18, 2008

(54) FLUID EJECTING APPARATUS AND METHOD FOR CONTROLLING DRIVING OF CAPS

(75) Inventor: Nobuhito TAKAHASHI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/137,084

(22) Filed: Jun. 11, 2008

(30) Foreign Application Priority Data
Jun. 12, 2007 (JP) 2007-155211

(51) Int. Cl. B41J 29/393; B41J 2/165

(52) U.S. Cl. 347/19; 347/29

(57) ABSTRACT

There is provided a liquid ejecting apparatus including: a liquid ejecting head capable of ejecting liquid; and a plurality of cap units each having a cap for individually capping a plurality of head areas of the liquid ejecting head. The plurality of cap units is constructed such that the shift position of each cap that is shifted from a retracted position toward the head area can be varied according to the distortion of the liquid ejecting head.

### BACKGROUND

The entire disclosure of Japanese Patent Application No. 2007-155211, filed Jun. 12, 2007 is expressly incorporated herein by reference.

1. Technical Field

The present invention relates to a fluid or liquid ejecting apparatus. More specifically, the present invention relates to a liquid ejecting apparatus including a cap unit for capping a liquid ejecting head and a method for controlling the driving of the caps.

2. Related Art

One example of a liquid ejecting apparatus that is currently known in the art is a printer, such as those disclosed in Japanese Patent JP-A-2007-69448 (as described in paragraphs [0050] and [0051] and FIGS. 7 and 8) and Japanese Patent JP-A-2005-67127 (as described in paragraph and FIGS. 2B and 12). The printers disclosed in the are line printers (line ink-jet recording apparatuses) which include a plurality of staggered record heads disposed between a plurality of transport belts. There is a plurality of cap units (head recovery units) below the record heads which correspond with the record heads in a one-to-one correspondence. The cap units each have a cap that can cap the nozzle surface of a corresponding record head, and are configured to prevent the ink in the nozzles from thickening or drying by bringing the cap into contact with the nozzle surface.

The cap unit has a suction pump which serves as sucking means. Thus, the cap unit is used to clean the nozzles by driving the suction pump while the nozzles are capped in order to create a negative pressure in the interior of the cap, so that any thickened ink or air bubbles in the nozzles may be removed. The elevation strokes of the caps of the cap units are generally set at the same value.

However, one difficulty with the line head system is that the multiple head structure in which a large number of record heads are supported in a single support member or a long ling-head structure. Unfortunately, this means that any distortion in the support member of the multiple head structure results in a distortion of the line head itself.

The elevation strokes of the caps are the same among the cap units, as described above. Therefore, if the line head has an upward distortion, the adhesion of the caps to the nozzle surface may be decreased or; in contrast, if the line head has a downward distortion, an excessive contact pressure may be applied to the cap sealing member, resulting in excessive stress and wear on the cap sealing member.

### BRIEF SUMMARY OF THE INVENTION

One advantage of some aspects of the invention is a liquid ejecting apparatus in which variations in the caps in shift positions and the head areas of liquid ejecting heads can be reduced even when the liquid ejecting heads are deflected. Thus, one advantage of the present invention is a method for controlling the driving of the caps.

One aspect of the invention is a liquid ejecting apparatus comprising a liquid ejecting head capable of ejecting liquid and a plurality of cap units each having a cap for individually capping a plurality of head areas of the liquid ejecting head. The plurality of cap units are constructed such that the shift position of each cap can be varied in order to more accurately cap the head area, regardless of the distortion of the liquid ejecting head.

Using this structure, the caps can be brought into close contact with the corresponding head areas with substantially uniform and appropriate strength when the caps are moved to the capping positions. Thus, embodiments of the present invention are capable of capping the head areas more effectively than the capping mechanisms currently known in the art. When the caps are moved to the capping positions, the caps can be disposed in appropriate flushing positions a predetermined distance from the corresponding head areas This allows the caps to more accurately and efficiently capture the ejected liquid (drops).

Advantageously, this alleviates the staining of the interior of the liquid ejecting apparatus due to a mist of the drops that are not collected by the capping mechanism because the gaps between the nozzle surface and capping mechanism are excessively wide. In addition, embodiments of the present invention also prevent the any ink from rebounding from the caps and onto the head areas because the space between the caps and head areas is excessively narrow.

The shift-position data includes not only position data for use in determining shift positions but also moving-distance data for use in determining shift positions. This also applies to the following:

In this case, the controller controls the driving of the power source according to the shift-position data read from the memory. As a result, the caps can be disposed in appropriate shift positions according to the distortion of the liquid ejecting head. This reduces variations in the relative positions of the caps and the head areas.

With this arrangement, even if the liquid ejecting head is deflected across the length because of its own weight or a tightening force during assembly, the cap shift positions can be adjusted individually so as to compensate for the distortion. Thus, the caps can be moved to the shift positions so as to maintain a fixed position relationship relative to the liquid ejecting head.

A second aspect of the invention is a method for controlling the driving of the caps of a liquid ejecting apparatus which includes a liquid ejecting head capable of ejecting liquid, a plurality of cap units each having a cap for independently capping a plurality of head areas of the liquid ejecting head and a power source that outputs power for moving the cap, and a memory capable of storing a plurality of shift-position data according to the distortion of the liquid ejecting head in association with the caps. The method comprises moving the caps to the respective shift positions by controlling the driving of the power sources of the cap units according to the shift-position data read from the memory.

This offers advantages similar to those of the foregoing liquid ejecting apparatus.

A third aspect of the invention is a method for controlling the driving of the caps of a liquid ejecting apparatus including a liquid ejecting head capable of ejecting liquid, a plurality of cap units each having a cap for independently capping a plurality of head areas of the liquid ejecting head and a power source capable of outputting power for moving the cap, a measuring unit, and a memory. The method comprises measuring two or more gaps between the caps and the head areas according to the distortion of the liquid ejecting head using the measuring unit, storing shift-position data corresponding to the measured gaps into the memory, and moving the caps to the respective shift positions by controlling the driving of the power sources of the cap units based on the shift-position data read from the memory.

### BRIEF DESCRIPTION OF THE DRAWINGS

The invention will be described with reference to the accompanying drawings, wherein like numbers reference like elements.

FIG. 1 is a schematic sectional view of a printer, which represents a first embodiment of the invention;

FIG. 2A is a schematic plan view of the printer of FIG. 1;

FIG. 2B is a schematic side view of the printer of FIG. 1;

FIG. 3 is a bottom view of a record head comprising a line head;

FIG. 4 is a block diagram showing the electrical configuration of the printer;

FIG. 5 is a schematic view of the cap units and the line head in their retracted positions;

FIG. 6 is a schematic view of the cap units and the line head in the capping positions;

FIG. 7 is a diagram of table data stored in a flash memory;

FIG. 8 is a block diagram of the electrical configuration of a printer according to a second embodiment of the invention;

FIG. 9A is a bottom view of a line head;

FIG. 9B is a schematic view of the line head; and

FIG. 10 is a schematic diagram describing a distance measuring unit.

### DESCRIPTION OF EXEMPLARY EMBODIMENTS

### First Embodiment

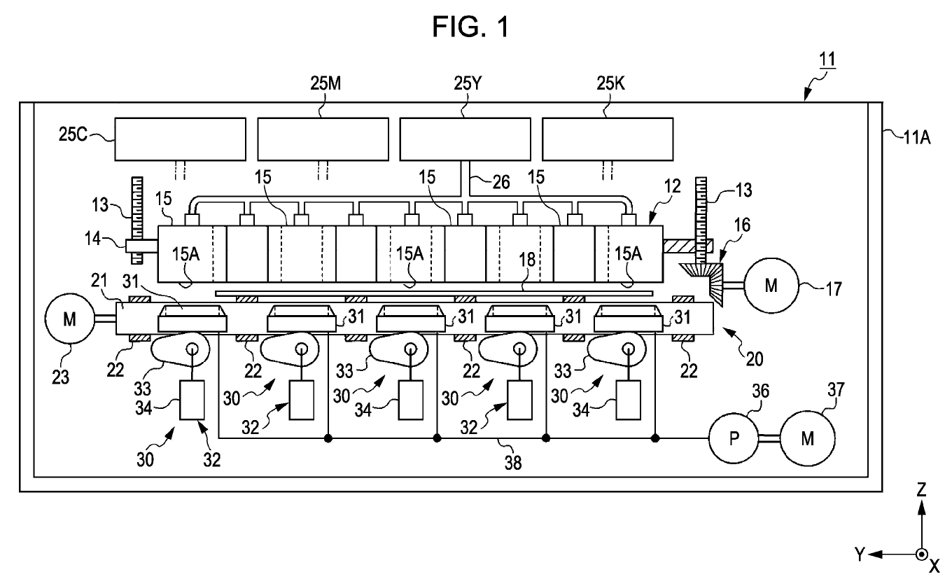

A first embodiment of the invention will be described herein with reference to FIGS. 1 to 7.

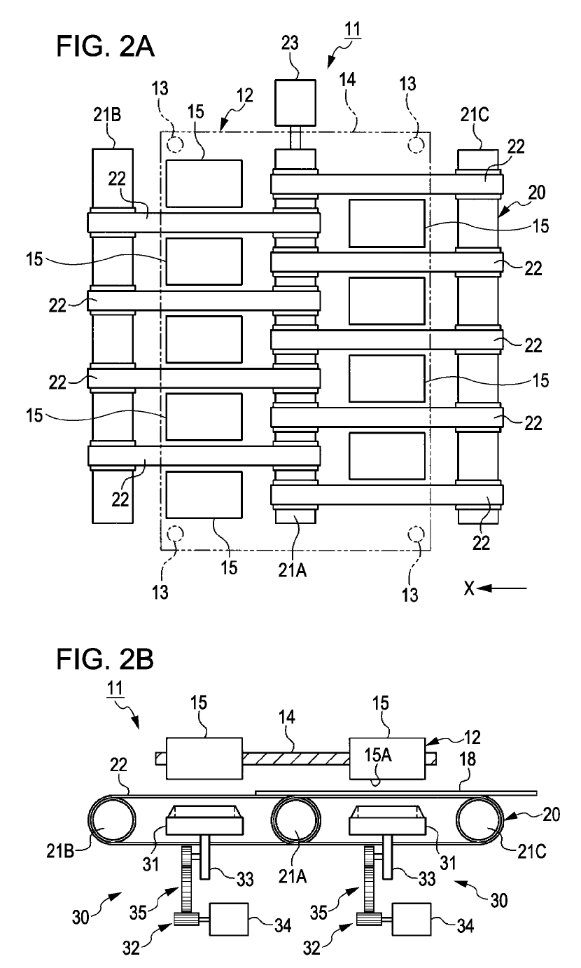

FIG. 1 is a schematic sectional view of an ink jet recording apparatus, which represents an exemplary embodiment of a liquid ejecting apparatus which may be used in association with the present invention. FIG. 2A is a plan view of the ink jet recording apparatus, and FIG. 2B is a side view of the same. FIGS. 2A and 2B omit a diagram of the ink supply system, including the ink cartridge.

As shown in FIGS. 1 and 2, in this example the ink jet recording apparatus (hereinafter, simply referred to as a printer 11) is a line printer having a line head 12 which acts as a liquid ejecting head, which extends across the entire maximum paper width. Depending on the specific configuration of the printer, in this example, four erect driving shafts 13 (two are shown in FIG. 1) are disposed in a box body case 11A which has an open top. A head support member 14 acts as a support frame, and is supported by the four driving shafts 13 which are screwed into the screw holes at the four corners of the head support member 14.

The head support member 14 supports a plurality of record heads 15, nine in this embodiment, which act as head areas or unit heads, which arranged along the width direction Y which is perpendicular to the paper transporting direction (the X-direction). As shown in FIG. 2A, the record heads 15 are arranged along the Y-direction in a configuration using two-rows of recording heads 15. In this embodiment, the plurality of record heads 15 and common head support member 14 comprise the line head 12.

The four driving shafts 13 are connected using a power transmission mechanism (not shown) so as to be rotated in synchronism. One of the driving shafts 13 is connected to an electric motor 17 via a gear mechanism 16 so as to allow power transmission. Therefore, the line head 12 can be moved up and down in the Z-direction in FIG. 1 by reversing the electric motor 17 in a forward and reverse direction.

As shown in FIGS. 1, 2A, and 2B, there is a transport unit 20 for transporting paper P, or other medium (target), to an area below the line head 12. The transport unit 20 includes three rollers 21A-21C (represented as a single roller 21 in FIG. 1) which are arranged in parallel such that their axes are oriented in the Y-direction, a plurality of transport belts 22 wound around multiple portions of the rollers 21A-21C at regular intervals along the axes, and an electric motor 23 that rotates the roller 21A. Specifically, the central roller 21A serves as a driving roller, and the two rollers 21B and 21C on both sides serve as driven rollers. Four transport belts 22 are wound between the pair of rollers 21A and 21B on the downstream side (shown on the left in FIG. 2), and five transport belts 22 are wound between the pair of rollers 21A and 21C on the upstream side. The record heads 15 are disposed in positions which correspond to the space between the transport belts 22.

When the electric motor 23 is driven to rotate the central roller 21A, the transport belts 22 are rotated, so that paper 18 placed on the transport belts 22 is transported in the X-direction (the paper transporting direction). The transport unit 20 of one embodiment employs an electrostatic attraction system whereby the paper 18 is transported while being attracted to the charged surface of the transport belts 22 by the static force. The line head 12 is moved up and down by the positive and reverse rotations of the electric motor 17, so that the gap between the record heads 15 and the paper 18 (or the upper surface of the transport belts 22) can be adjusted.

As shown in FIG. 1, there are four ink cartridges 25C, 25M, 25Y, and 25K above the line head 12 which contain cyan (C), magenta (M), yellow (Y), and black (K) inks, respectively. The inks in the ink cartridges 25C, 25M, 25Y, and 25K are supplied to the respective record heads 15 through a series of ink feed tubes 26 (shown as a single tube in FIG. 1). Alternatively, the liquid supply source (liquid container) may be an ink tank in place of the ink cartridge. In another embodiment, the ink supply system may be one that uses a water head difference or a pressure feed system that uses pressure air or the like.

As shown in FIG. 1, cap units 30 are disposed below the record heads 15, respectively. The cap units 30 each include a cap 31 for capping the nozzle surface 15A of the record head 15 and a lifting mechanism 32 for moving the cap 31 up and down. The lifting mechanism 32 includes a cam 33 (rotary cam) that is in contact with the bottom of the cap 31 and an electric motor 34 which serves as a power source for rotating the cam 33 in forward and reverse directions FIG. 1 shows the lifting mechanism 32 schematically, which is described more specifically in FIG. 2B. The rotation shaft of the cam 33 is connected to the driving shaft of the electric motor 34 via a gear mechanism 35 so as to transmit power. When the electric motor 34 rotates in the forward direction, the cam 33 is rotated clockwise from the position shown in FIG. 1 to move the cap 31 upward to the capping position (the uppermost position) from the retracted position (the lowermost position). In contrast, when the electric motor 34 rotates in the reverse direction from the capping position of the cap 31, the cam 33 is rotated counterclockwise and the cap 31 is moved downward to the retracted position (the lowermost position). The cap 31 can also be disposed in a flushing position between the retracted position and the capping position.

As shown in FIG. 1, the caps 31 are connected to the discharge port of a suction pump 36 via a tube 38. The suction pump 36 is connected to a pump motor 37 so as to transmit power. When the pump motor 37 is driven during a capping state when the caps 31 are in contact with the nozzle surfaces 15A of the record heads 15, a negative pressure is applied into the caps 31 via the tube 38, so that sucking force or negative pressure is applied to the nozzles open in the nozzle surfaces 15A, causing the thickened ink or bubbles to be sucked from the nozzles, thereby cleaning the nozzles.

Since the cap units 30 each have an electric motor 34, the elevation strokes of the caps 31 can be controlled independently by controlling the electric motors 34 individually. In place of the mechanism using the rotary cam 33, the lifting mechanism 32 may adopt a mechanism using a cylindrical cam or a mechanism using, which uses a cylinder, a solenoid, or a piezoelectric actuator as a power source.

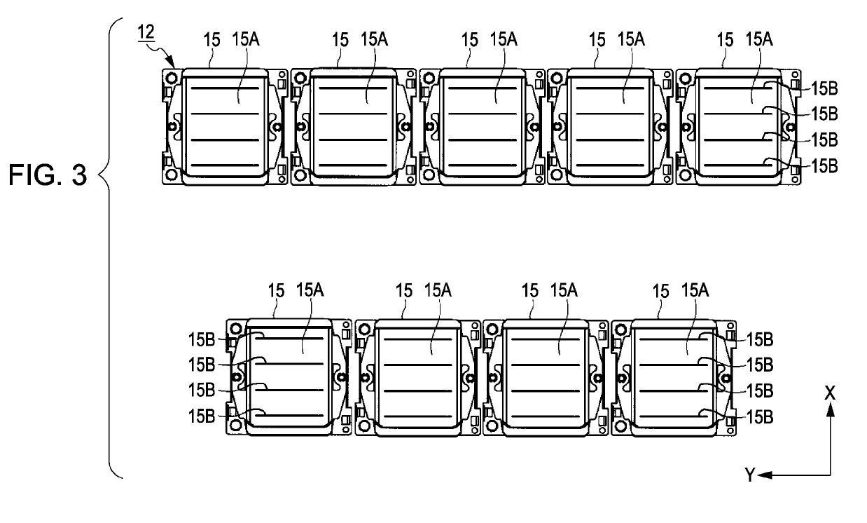

FIG. 3 shows a bottom view of the line head 12 as viewed from the nozzle opening surface. FIG. 3 omits the head support member. The nozzle surface 15A, which are the lower or bottom surfaces of the record heads 15, which are arranged with a plurality of nozzles that are arranged in a two-row staggered configuration in the width Y-direction, with four nozzle trains 15B corresponding to the four colors of ink. One nozzle train 15B has a large number of nozzles (for example, 180), which are arranged in a staggered configuration. The record heads 15 each have four channels corresponding to the nozzle trains 15B, where inks of corresponding colors are fed. Thus, nozzles that constitute the same nozzle train 15B eject ink of the same color.

The record heads 15 have an ejection driving device for each nozzle (both are not shown). When the ejection driving devices are driven to apply ejecting force to the ink, ink drops are ejected from the nozzles. Examples of systems that may be used for driving ejection are a piezoelectric systems, which use a piezoelectric vibrating device, an electrostatic system that uses an electrostatic device, and a thermal system that uses a heater.

Since the record heads 15 are arranged in a staggered configuration, at least the endmost nozzles at both ends of the nozzle train of the record heads 15 in the first row (the upper row in FIG. 3) and those of the second row overlap or continue with a nozzle pitch therebetween, as viewed from the paper transporting direction X (the vertical direction in FIG. 3). This allows printing in the maximum paper width range even if the line head 12 is fixed.

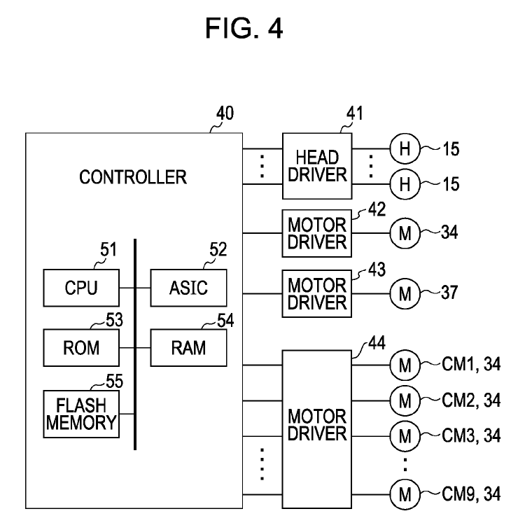

FIG. 4 shows the electrical structure of the printer 11. As shown in FIG. 4, the printer 11 includes a controller 40, a head driver 41 and motor drivers 42-44. The controller 40 is connected to the record heads 15 via the head driver 41, to the electric motor 34 via the motor driver 42, and to the pump motor 37 via the motor driver 43. The controller 40 is also connected to electric motors CM1 to CM9 (34) via the motor driver 44. The nine electric motors 34 of the lifting mechanism 32 are denoted by symbols CM1 to CM9, respectively, in FIGS. 4 to 6.

The controller 40 includes a CPU 51, an application specific IC (ASIC) 52, a ROM 53, a RAM 54, and a flash memory 55. The ROM 53 stores various programs for the CPU 51. The RAM 54 is used as a work memory for the CPU 51 for temporarily storing data such as calculations. The flash memory 55 stores data regarding the drive amounts of the electric motors CM1 to CM9 (34) for determining the elevation strokes of the caps 31.

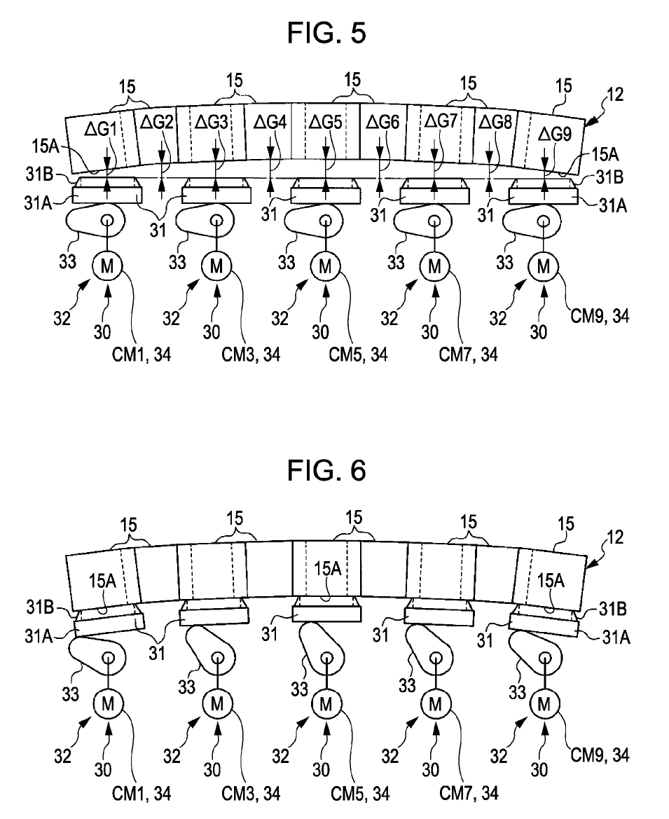

The drive amount data is written to the flash memory 55 in using a system shown in FIG. 5 First, the head support member 14 deflects due to the weight of the record heads 15 or in response to a tightening force resulting from the manufacturing process of the line head 12, which causes a slight but nonnegligible warp in the line head 12. To adjust the elevation stroke of each cap 31 to the warp, drive amount data is written to the flash memory 55 prior to shipment of the printer 11.

First, the caps 31 are disposed in retracted positions, and the gaps between the caps 31 and the nozzle surfaces 15A are measured for all the cap units 30 using a gap gauge, for example. The caps 31 each have a rectangular ring-shaped sealing member 31B made of an elastic material such as elastomer which is integrally formed on a holding member 31A made of synthetic resin. The gap ΔG between the end of the sealing member 31B and the nozzle surface 15A is measured

Let the gap ΔG be ΔG1 to ΔG9 from the left cap unit 30 to the right. In the example of FIG. 5, the line head 12 warps such that the center deflects upward, so that the gap ΔG5 between the record head 15 and the cap 31 in the center of the head train is the greatest of all the gaps between the caps 31 and the recording head. Thus, the ΔG is the greatest at the center and decreases to both ends of the line head 12. Then, the positions at which the caps 31 can contact with the nozzle surfaces 15A with an appropriate contact pressure and the flushing positions apart from the nozzle surfaces 15A by a fixed distance are calculated as drive amount data indicated by values corresponding to the drive amounts of the electric motors CM1 to CM9, and the calculated drive amount data is written to the flash memory 55. The flushing indicates an action wherein ink drops irrelevant to printing are discharged in order to expel or eliminate any thickened ink in the nozzles during printing. The flushed ink drops are ejected into the caps 31.

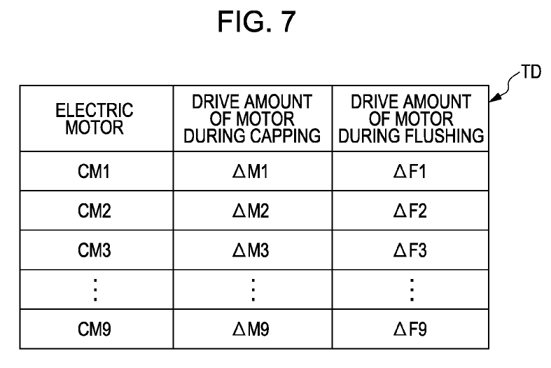

FIG. 7 shows table data that may be stored in the flash memory 55. As shown in FIG. 7, the flash memory 55 stores table data TD indicating which motor drive amounts ΔM1 to ΔM9 during capping and motor drive amounts ΔF1 to ΔF9 during flushing are in correspondence with the electric motors CM1 to CM9. In this embodiment, the motor drive amounts ΔM1 to ΔM9 and the motor drive amounts ΔF1 to ΔF9 correspond to shift-position data

Here, the capping positions are each obtained as the elevation stroke of the cap 31 by adding a distance AD necessary for compression-deforming the sealing member 31B to the gap ΔG so as to bring the cap 31 into contact with the nozzle surface 15A at an appropriate contact pressure. Then motor drive amounts ΔM1 to ΔM9 corresponding to the capping positions are calculated and written to the flash memory 55. The flushing positions are each set at a position where a gap can be provided between the cap 31 and the nozzle surface 15A. Preferably, the gap is sufficiently small so that the ink drops ejected during flushing are not splashed as a mist before arriving at the caps 31 and not so narrow that the ejected ink drops do not rebound from the caps 31 onto the nozzle surface 15A. The flushing positions are also uniquely calculated from the gap ΔG. Then, motor drive amounts ΔF1 to ΔF9 corresponding to the calculations are calculated and written to the flash memory 55. The motor drive amounts ΔM and ΔF are calculated from the origin, or the location where the rotational position (rotation angle) of the motor at which the cap 31 is at the retracted position.

In the previously described embodiment, the warp of the line head 12 shown in FIG. 5 is shown by way of example. The specific shape of the warp depends on the specific line head 12 support structure and the combining conditions of the line head 12, such as the tightening force. For example, the center of the line head 12 can be displaced downward. Then, data on the motor drive amount corresponding to the warp shape is written to the flash memory 55.

When controlling the driving of the cap units 30, the controller 40 counts the motor drive amounts from the origin corresponding to the retracted positions using nine counters which correspond to the electric motors CM1 to CM9 in order to thereby manage the positions of the caps 31. During standby before printing, the caps 31 are disposed in the capping positions. Upon reception of a print instruction, the controller 40 moves the caps 31 downward to the flushing positions. In other words, the controller 40 reads the motor drive amounts ΔF1 to ΔF9 corresponding to the electric motors CM1 to CM9 during flushing from the flash memory 55, and drives the electric motors CM1 to CM9 in the reverse direction by a motor drive amount (ΔM1−ΔF1) to a motor drive amount (ΔM9−ΔF9), respectively. Then, the controller 40 stops the driving of the electric motors CM1 to CM9 at the time the nine counters corresponding to the electric motors CM1 to CM9 are decreased to values ΔF1 to ΔF9, respectively. As a result, the caps 31 are disposed in the appropriate flushing positions a predetermined distance from each of the nozzle surfaces 15A Thus, the caps 31 may be disposed at different heights due to the warp of the line head 12. Advantageously, this prevents the problem of staining the interior of the printer 11 with a mist of ink drops that are ejected during flushing without arriving at the caps 31 or staining the nozzle surfaces 15A with ink drops rebounding from the caps 31.

After completing the printing process, the controller 40 reads the motor drive amounts ΔM1 to ΔM9 recorded during the capping from the flash memory 55, and drives the electric motors CM1 to CM9 until the counters reach the corresponding motor drive amounts ΔM1 to ΔM9. As a result, the caps 31 come into contact with the corresponding nozzle surfaces 15A at uniform and appropriate contact pressure even if the heights of the nozzle surfaces 15A are varied because of the warp of the line head 12. This prevents the problem where there is a decrease in moisture retention in the caps 31 due to the presence of a small gap and due to insufficient contact pressure of the caps 31, each of which causes clogging of the nozzles, or a decrease in the durability of the caps 31 due to the rapid wear or deformation of the sealing members 31B because of the strong contact pressure of the caps 31.

Thus, the above-described embodiment offers the following advantages:

1. Since the elevation strokes of the caps 31 are controlled individually and independently according to preset values according to the warp of the line head 12, the caps 31 can be brought into contact with the nozzle surfaces 15A with a uniform and appropriate contact pressure even if the distance to the record heads 15 varies because of the warp of the line head 12.

2. This embodiment employs a method of capturing and storing the motor drive amounts ΔM1 to ΔM9 during the capping process and the motor drive amounts ΔF1 to ΔF9 during the flushing process. These quantities are obtained using a measuring instrument such as a gap gauge and are stored into the flash memory 55 as default values. This allows control when the elevation strokes of the caps 31 vary individually, and does not require a range sensor to measure the gap ΔG.

3. Since data on the motor drive amounts ΔF1 to ΔF9 which corresponds to the flushing positions is also stored in the flash memory 55, the caps 31 can be disposed in appropriate flushing positions corresponding to the heights of the nozzle surfaces 15A. This effectively prevents the problem of staining the interior of the printer 11 with a mist of ink drops ejected during flushing or the problem of ink drops rebounding from the caps 31 to the nozzle surface 15A during flushing. Thus, this structure can prevent a deterioration in print quality.

### Second Embodiment

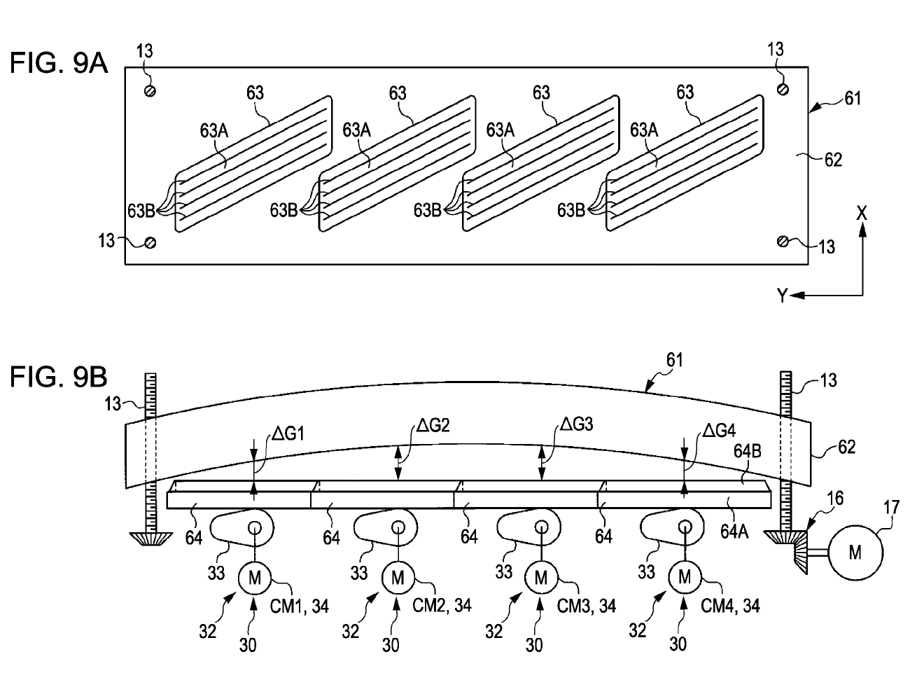

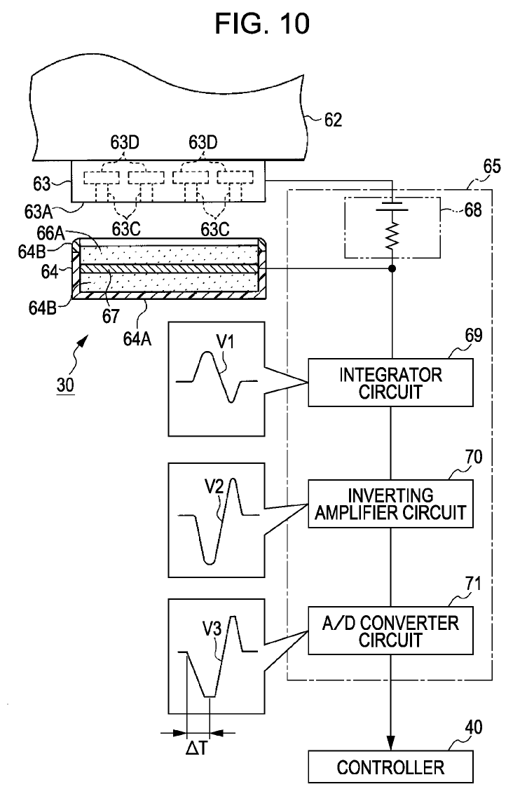

A second embodiment of the invention may be described using another printer as an example. The printer includes including a range sensor for measuring the distance between nozzle surface and caps. FIG. 9A is a bottom view of the line head as viewed from the nozzle surface FIG. 9B is a schematic front view of the printer. FIG. 9B shows an example in which a line head 61 warps.

As shown in FIG. 9A, the line head 61 includes a long-rectangular-plate head support member 62 and a plurality of record heads 63, which are head areas or unit heads that are embedded in the head support member 62. The nozzle surfaces 63A of the record heads 63 each have a plurality of nozzle trains 63B (four, in this example) which correspond to the colors of ink (which is also four in this example). The nozzle trains 63B of the same color of the record heads 63 communicate with one another through the same channel in the head support member 62. The record heads 63 are arranged such that the nozzle trains 63B are inclined at a predetermined angle (for example, 20 to 60 degrees) with respect to the length of the line head 61 The nozzle trains 63B of adjacent record heads 63 are placed in relation to each other such that the nozzles at the ends overlap or the endmost nozzles continue, with a nozzle pitch therebetween, as viewed along the paper transport direction X.

As shown in FIG. 9B, the head support member 62 is supported by the four driving shafts 13 which are screwed into the screw holes at the four corners of the head support member 62, as in the first embodiment. The line head 61 is moved up and down along the driving shafts 13 by the forward and reverse rotation of the four driving shafts 13 via the gear mechanism 16 by the forward and reverse rotation of the electric motor 17. The plurality of cap units 30 are arranged in the corresponding positions below the record heads 63 of the line head 61. The cap units 30 have principally the same structure as that of the first embodiment, which comprise caps 64, the lifting mechanisms 32, and the electric motors CM1 to CM4 (34).

As shown in FIG. 9A, the diagonal arrangement of the record heads 63 provides areas, around the nozzle surfaces 63A, with which the caps 64 can be brought into contact without interfering with the caps 64 that cover adjacent nozzle surfaces 63A. This allows the nozzle surfaces 63A to be covered with different caps 64.

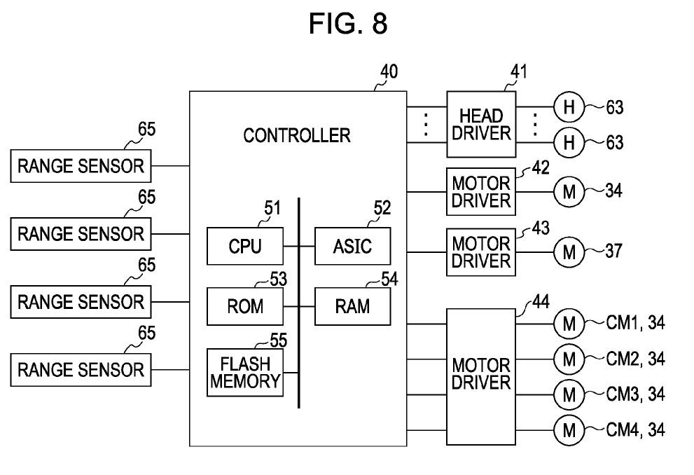

FIG. 8 shows the electrical structure of the printer. The printer of this embodiment has substantially the same structure as that of the first embodiment except that it has range sensors 65 shown in FIG. 8. The controller 40 are connected to four range sensors 65 which correspond to the number of caps 64. The range sensors 65 each measure the distance between the nozzle surface 63A and the cap 64. The range sensors 65 and the controller 40 constitute a distance measuring unit.

FIG. 10 shows the distance measuring unit including the range sensor 65. The range sensor 65 (indicated by an alternate long and short dashed line in FIG. 10) includes a voltage applying circuit 68 (indicated by a chain double-dashed line in FIG. 10) for applying voltage to an electrode 67 disposed in the cap 64 and to the nozzle surface 63A of the record head 63 and an integrator circuit 69 that integrates a detected signal sent from the electrode 67 and outputs it. The range sensor 65 further includes an inverting amplifier circuit 70 that inverts and amplifies the signal output from the integrator circuit 69 and outputs it and an A/D converter circuit 71 that converts the signal output from the inverting amplifier circuit 70 from analog to digital and outputs the converted signal to the controller 40. The electrode 67 is disposed between upper and lower ink absorbers 66A and 66B disposed in two layers in the cap 64.

The voltage applying circuit 68 includes a direct-current power source (for example, 400 V) and a resistor element (for example, 1 MΩ) such that the electrode 67 becomes positive and the nozzle surface 63A of the record head 63 become negative. Therefore, the upper surface of the upper ink absorber 66A becomes positively charged, while the nozzle surface 63A of the record head 63 becomes negatively charged.

The principle of measurement of the distance (gap) between the nozzle surface 63A and the cap 64 using the range sensor 65 will be described. First, the cap 64 is disposed in the retracted position. The distance measurement is executed by driving ejection driving devices 63D which cause a plurality of ink drops to be ejected from nozzles 63C into the cap 64. The ink drops ejected from the nozzles 63C become negatively charged. As the negatively charged ink drops come close to the cap 64, the positive charge on the ink absorber 66A increases by electrostatic induction. When the ink drops land on the ink absorber 66A, the positive charge of the previously landed portion is neutralized by the negative charge of the ink drops. Therefore, the potential difference measured between the electrode 67 and the nozzle surface 63A temporarily becomes smaller than the initial potential difference before the ejection of the ink drops. Then, the neutralized ink drops become positively charged, and the measured potential difference returns to the initial potential difference. During the course of this process, a voltage waveform signal V1 corresponding to the change in measured potential difference, shown in FIG. 10, is input to the integrator circuit 69. The voltage waveform signal V1 is inverted and amplified by the inverting amplifier circuit 70 and is output as a voltage waveform signal V2. The voltage waveform signal V2 is converted from analog to digital by the A/D converter circuit 71 and is output as a voltage waveform signal V3 to the controller 40.

In this embodiment, ink drops are ejected from the nozzles 63C at the center of the nozzle trains 63B at the same time The detection signals of the ink drops ejected from the record heads 63 are input from the respective range sensors 65 to the controller 40.

The CPU 51 in the controller 40 determines a travel time ΔT (the time required) required for the ink drops ejected from the nozzle 63C to land on the upper surface of the ink absorber 66A from the voltage waveform signal V3 input from the range sensor 65, and calculates the distance D (ink splash distance) by equation D=V·ΔT using the travel time ΔT and a known ink splashing speed V. The travel time ΔT is the time that the voltage waveform signal V3 in FIG. 10 took to change from the rising from the initial potential difference to the first peak.

The CPU 51 calculates the distance Dn (n is an identifier for discriminating the four caps 64) between the nozzle surface 63A and each cap 64 (the upper surface of the ink absorber 66A). In other words, the flash memory 55 stores another table data indicative of the relationship among the distance Dn and the motor drive amounts ΔM and ΔF. The CPU 51 finds motor drive amounts ΔM1 to ΔM4 during a capping process and motor drive amounts ΔF1 to ΔF4 during a flushing process from the distance Dn, and writes them into the flash memory 55. As a result, the flash memory 55 stores the table data TD similar to that shown in FIG. 7. The gaps ΔG1 to ΔG4 between the record heads 63 of the line head 12 and the sealing members 64B, shown in FIG. 9B, are equal to the distance that is obtained by subtracting the distance between the upper end of the sealing member 64B and the upper surface of the ink absorber 66A from the distance Dn. The motor drive amounts ΔM1 to ΔM4 and ΔF1 to ΔF4 correspond to the gaps ΔG1 to ΔG4. In this embodiment, the distance between the record head 63 and the cap 64 is measured as the distance between the record head 63 and the ink absorber 66A or the area within the interior of the cap 64. The timing of measurement by the range sensors 65 can be set to the time when the frequency of cleaning becomes high, at the time of manual operation, and at regular intervals ranging from one month to one year.

When moving the caps 64 to the capping positions, the controller 40 reads data on the motor drive amounts ΔM1 to ΔM4 corresponding to the electric motors CM1 to CM4 from the flash memory 55, and drives the electric motors CM1 to CM4 until the counters reach the values of the motor drive amounts ΔM1 to ΔM4.

Thus, even if the line head 61 warps and therefore the heights of the nozzle surfaces 63A vary, the elevation strokes of the caps 64 can be controlled according to the measured distances between the nozzle surfaces 63A and the caps 64. Accordingly, every cap 64 is brought into close contact with the nozzle surfaces 63A with appropriate contact pressures.

When moving the caps 64 to the flushing positions, the controller 40 first reads data on the motor drive amounts ΔF1 to ΔF4 corresponding to the electric motors CM1 to CM4 from the flash memory 55, and drives the electric motors CM1 to CM4 until the counters reach the values of the motor drive amounts ΔF1 to ΔF4. Thus, even if the line head 61 warps, causing the heights of the nozzle surfaces 63A to vary, the elevation strokes of the caps 64 to the flushing positions can be controlled according to the measured distances between the nozzle surfaces 63A and the caps 64. Accordingly, every cap 64 is separated from the nozzle surfaces 63A by a fixed distance.

Accordingly, the second embodiment offers the following advantages:

5. When the frequency of the cleaning processes is high, the distances between the nozzle surfaces 63A and the caps 64 can be measured using the range sensors 65 at the time of manual operation and at regular intervals ranging from one month to one year. This allows continuous update of data. Accordingly, even if the degree of the warp of the line head 61, that is, the heights of the nozzle surfaces 63A of the record heads 63 change with time, the caps 64 can be brought into close contact with the nozzle surfaces 63A with appropriate contact pressures. Since this embodiment is constructed to measure the distances between the caps 64 and the nozzle surfaces 63A using the range sensors 65, and to determine the elevation strokes of the caps 64 from the measurements, secular changes in the positions of the record heads 63 can also be used in association with the present invention

It is to be understood that the invention is not limited to the foregoing embodiments and the following modifications may be made.

### First Modification

The cap moving distance may not necessarily be varied. In other words, the shift positions, including the capping positions and the flushing positions need only to be changed according to the distortion of the line head. For example, another structure may be adopted in which the retracted positions, or lowermost positions, of the caps are adjusted according to the distortion of the line head wherein the cap shift positions are adjusted according to the distortion of the line head by setting the travel strokes of the caps from the retracted positions to the capping positions or the flushing position to the same value for any cap.

### Second Modification

While the invention is configured to cope with the warp (distortion) of the line head, various another applications or uses may be made in association with the present invention. For example, the invention may be applied to correct variations in the height of the caps due to variations in the height of the cap unit mount positions. The invention may be used to adjust of the elevation strokes of the caps in order to prevent a decrease in the tightness of the caps due to the wear or deformation of the sealing members of the caps. In a word, the application should be individual adjustments of the elevation strokes of the caps.

### Third Modification

The positions of the cap units themselves may be adjusted. For example, the invention may adopt a structure in which the cap positions are adjusted according to the warp of the line head by vertically adjusting the cap unit mount positions using a spacer between the bottom of the frame body and the cap units when the cap units are mounted on the frame body. With this structure, the elevation strokes of the caps 31 can be made equal among the cap units 30.

### Fourth Modification

While the foregoing embodiments adopt a transport belt mechanism as a transport unit for transporting target paper, another printer structure may be adopted in which paper is transported by a transport roller and a platen is disposed directly under the record heads.

### Fifth Modification

The first embodiment may use a long line head, while the second embodiment may use a line head in which a plurality of record heads are disposed in a staggered configuration. In this case, the number of rows of the record heads is not limited to two but may be three, four, five or more. The invention may adopt another structure in which record heads in different rows are supported by respective head support members.

### Sixth Modification

The distance measuring unit may not be provided for each cap buy may be provided for every other cap. Furthermore, in some situations, only three caps are needed when the caps at both ends and the central ca have range sensors. If the distortion along the length of the line head is in symmetric about the center, the gap between the line head and the caps may be measured at two positions, one end and the center of the length of the line head. The distance measuring unit is not limited to a system of finding distances from changes in potential difference of charged ink drops during flushing. For example, a distance measuring unit of another system, such as a laser length measuring machine, may be adopted.

### Seventh Modification

The printer, which is a liquid ejecting apparatus, may be used by any number of devices and is not limited to the line printer For example, the invention may be applied to serial printers that print while a record head moves (scans) along the paper width. Such serial printers can offer similar advantages, provided that the proportion of the length of the head to the maximum paper width is high.

### Eighth Modification

While the liquid ejecting apparatuses of the embodiments are ink jet recording apparatuses, the invention is not limited to that, and the invention may be embodied as a liquid ejecting apparatus that ejects or discharges another liquid other than ink (such as liquids, liquid-form matter in which functional particles are dispersed or mixed in liquid, liquid-form matter such as gels, or flowing solid matter that can be ejected For example, the invention may be applied to a liquid-form-matter ejecting apparatus that ejects liquid-form matter that contains a dispersed or dissolved electrode material or color material (pixel material) for use in manufacturing liquid crystal displays, electroluminescence (EL) displays, and surface emitting displays. Moreover, the present invention may be applied to a liquid ejecting apparatus that ejects bioorganic matter for use in manufacturing bio chips and a liquid ejecting apparatus serving as a precision pipette that ejects sample liquid. Other applications include a liquid ejecting apparatus that ejects lubricant for use in precision machines, such as watches and cameras, with pinpoint precision, a liquid ejecting apparatus that ejects transparent resin liquid, such as ultraviolet curable resin, onto a substrate to form a microhemispherical lens (optical lens) for use in optical communication devices, a liquid ejecting apparatus that ejects etching liquid, such as acid or alkali, to etch a substrate. and a liquid-form-matter ejecting apparatus that ejects liquid-form matter, such as gel (for example, physical gel). The “liquid” does not include liquid that contains only gas and includes liquids (including inorganic solvents, organic solvents, solutions, liquid resins, and liquid metals (metallic melts)), liquid-form matter, and liquid-form matter.

What is claimed is:

1. A liquid ejecting apparatus comprising:
a liquid ejecting head capable of ejecting liquid; and
a plurality of cap units each having a cap for individually capping a plurality of head areas of the liquid ejecting head, wherein
the plurality of cap units that are capable of varying the shift position of each cap that is shifted from a retracted position toward the head area according to the distortion of the liquid ejecting head.

2. The liquid ejecting apparatus according to claim 1, wherein the distance that each cap from the retracted position to the shift position is variable.

3. The liquid ejecting apparatus according to claim 1, wherein the shift position is at least one of a capping position and a flushing position.

4. The liquid ejecting apparatus according to claim 1, wherein
the plurality of cap units each comprise a power source that outputs power for moving the cap; wherein
the liquid ejecting apparatus further comprises:
a memory capable of storing shift-position data for each cap; and
a controller capable of driving the power sources according to the shift-position data read from the memory so that the caps are moved from the retracted positions to the shift positions.

5. The liquid ejecting apparatus according to claim 1, further comprising:
a measuring unit capable of measuring at least two gaps between the head areas and the caps;
a memory unit;
a writing unit capable of storing shift-position data corresponding to the gaps measured by the measuring unit in the memory; and
a controller capable of driving the power sources of the cap units using the shift-position data stored in the memory so as to move the caps to the shift positions.

6. The liquid ejecting apparatus according to claim 5, wherein the measuring unit measures a change in the voltage of the caps using electrostatic induction when liquid that is charged with the electric potential of the liquid ejecting head is ejected from the liquid towards the caps in order to determine the size of the gaps.

7. The liquid ejecting apparatus according to claim 1, wherein the liquid ejecting head is a line head in which a plurality of unit heads are supported across an area corresponding to the maximum width of a printing medium, which is orthogonal to a transporting direction; and the shift positions of the caps are set so as to correspond with the distortion of the liquid ejecting head in the direction of the arrangement of the unit heads.

8. A method for controlling the driving of the caps of a liquid ejecting apparatus including a liquid ejecting head capable of ejecting liquid, a plurality of cap units each having a cap capable of individually capping a plurality of head areas of the liquid ejecting head and a power source capable of outputting power for moving the cap, and a memory capable of storing shift-position data according to the distortion of the liquid ejecting head in association with the caps, the method comprising:
moving the caps to the respective shift positions by driving of the power sources of the cap units according to the shift-position data stored in the memory.

9. A method for controlling the driving of the caps of a liquid ejecting apparatus including a liquid ejecting head capable of ejecting liquid, a plurality of cap units each having a cap for individually capping a plurality of head areas of the liquid ejecting head, a power source that outputs power capable of moving the cap, a measuring unit, and a memory, the method comprising:
measuring the distortion of the liquid ejecting head by measuring the gaps between the caps and the head areas using the measuring unit;
storing shift-position data corresponding to the measured gaps into the memory; and
moving the caps to the respective shift positions by controlling the driving of the power sources of the cap units based on the shift-position data read from the memory.

10. A liquid ejecting apparatus comprising:
a liquid ejecting head capable of ejecting liquid;
a plurality of cap units, each having a cap for individually capping a plurality of head areas of the liquid ejecting head and a power source that outputs power for moving the cap;
a measuring unit capable of measuring at least two gaps between the head areas and the caps;
a memory unit;
a writing unit capable of storing shift-position data corresponding to the gaps measured by the measuring unit in the memory; and
a controller capable of driving the power sources of the cap units using the shift-position data stored in the memory so as to move the caps to the shift positions;
wherein the plurality of cap units that are capable of varying the shift position of each cap that is shifted from a retracted position toward the head area according to the distortion of the liquid ejecting head

11. The liquid ejecting apparatus according to claim 10, wherein the measuring unit measures a change in the voltage of the caps using electrostatic induction when liquid that is charged with the electric potential of the liquid ejecting head is ejected from the liquid towards the caps in order to determine the size of the gaps

12. The liquid ejecting apparatus according to claim 10, wherein the liquid ejecting head is a line head in which a plurality of unit heads are supported across an area corresponding to the maximum width of a printing medium, which is orthogonal to a transporting direction; and the shift positions of the caps are set so as to correspond with the distortion of the liquid ejecting head in the direction of the arrangement of the unit heads.
